(19) United States
(12) Patent Application Publication
(10) Pub. No.: US 2008/0098919 A1
(43) Pub. Date: May 1, 2008

(54) Method for erasing a printing form

(75) Inventors: Horst Dauer, Rohrbach (DE); Peer Dilling, Friedberg (DE); Andreas Feil, Olching (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/975,183

(22) Filed: Oct. 18, 2007

(30) Foreign Application Priority Data
Oct. 18, 2006 (DE) 10 2006 049 149.1

(51) Int. Cl. B41N 1/00

(52) U.S. Cl. 101/483

(57) ABSTRACT

A method for erasing the surface of a rewritable printing form within a printing press in which the form cylinder carrying the printing form rotates during the erasing process, wherein the erasure is performed over the course of two main erasing steps. That is, a first main erasing step is performed during the run-down of the form cylinder upon completion of a printing order, whereupon the second main erasing step performed, for which purpose the form cylinder is again driven after it has run down.

### BACKGROUND OF THE INVENTION

1. Field of the Invention

The present invention generally relates to the field of printing presses and, more particularly, to a method for erasing a permanent image on a surface of a rewritable printing form.

2. Description of the Related Art

Generally, when printing is performed with a printing form, a distinction is created between processes that work with a write-once printing form and those that work with rewritable printing forms. Printing processes that use rewritable printing forms also fall within the phrase “computer-to-press/direct imaging”.

The present applicant is engaged in the sale and marketing of digital printing presses under the name “DICOweb”, which work with rewritable and erasable printing forms. In the production of these types of printing forms, a printing form base cylinder is preferably subjected to an erasing step or image-removing step and to a following or subsequent image-forming step. The basic features of the DICOweb technology are described in Helmut Kipphan: Handbuch der Printmedien (Handbook of Print Media), Springer-Verlag, 2000, pages 674-680.

An erasing device which can be used to erase a rewritable printing form is disclosed in DE 100 08 214 A1. According to DE 100 08 214 A1, the erasing device comprises a cleaning cloth. This cleaning cloth is unwound from a roll of fresh cloth and pressed by a pressure element against the surface of the printing form to be erased. The consumed cleaning cloth is then wound onto a dirty cloth roll. Therefore, there is a lapse of time associated with cleaning the printing form and disposing of the dirty cleaning cloth, which contributes to an increase of printing costs.

In conventional printing presses that use rewritable printing forms for printing, the erasure of a printing form is performed as a completely independent step, which is performed while the printing press is being set-up. However, such a process consumes a considerable amount of time and, thus, printing time is lost while the machine is cleaned during set-up.

### SUMMARY OF THE INVENTION

An object of the present invention is to provide a method for erasing a printing form that solves the foregoing problems.

These and other objects and advantages are solved in the present invention by a method for erasing the surface of a rewritable printing form located within a printing press, where the form cylinder carrying the printing form rotates during the erasure of the surface of the printing form such that the set-up time of the printing press can be reduced.

In accordance with an embodiment of the present invention, the erasure is accomplished over the course of two main erasing steps, where a first main erasing step is conducted during the run-down of the form cylinder upon completion of a printing order, and a second main erasing step is then performed, for which purpose the form cylinder is re-started after it has run-down.

More particularly, the erasure is preferably conducted over the course of the two main erasing steps, where the first main erasing step is carried out during the run-down of the form cylinder and, thus, during the run-down of the printing press after completion of a printing order. The first main erasing step is therefore performed in parallel with the run-down of the form cylinder, for which run-down is necessary in any event. As a result, the required set-up time can be reduced by the time required for the form cylinder to run-down and during which the first main erasing step is performed.

The cylinder is still turning at high speed while the form cylinder is running down. As a result, a printing form positioned on the cylinder can be effectively cleaned during the first main erasing step in a relative short period of time.

In accordance with an advantageous embodiment of the invention, during the first main erasing step a preliminary cleaning of the surface of the rewritable printing form is performed (i.e., pre-cleaned), during which ink and image-forming polymer are removed from the surface and the surface is preferably dried. In addition, during the second main erasing step, a final cleaning of the surface of the rewritable printing form which has been pre-cleaned in the first main cleaning step is performed, where all remaining dirt is then removed from the surface of the printing form.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The various features, functions and advantages characterizing the invention will be better understood by reference to the detailed description which follows, taken in conjunction with the accompanying drawing.

FIG. 1 shows a flow chart of the method in accordance with an exemplary embodiment of the invention.

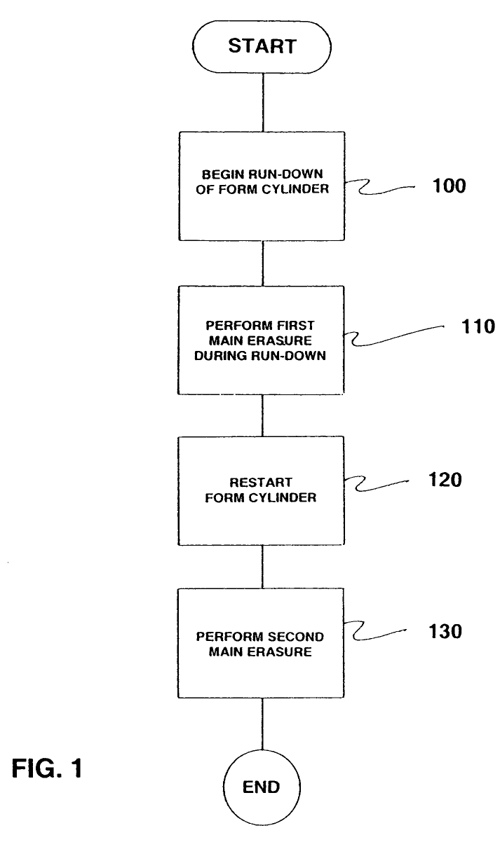

### DETAILED DESCRIPTION OF THE PRESENTLY PREFERRED EMBODIMENTS

The present invention relates to printing processes that work with erasable and rewritable printing forms. In particular, the invention relates to a method for erasing a rewritable printing form located within a printing press. In accordance with an embodiment of the present invention, the erasure of the surface of the rewritable printing form is performed within the printing press, i.e., over the course of two main erasing steps. A first main erasing step is performed during run-down of the form cylinder, upon which the printing form to be erased is positioned. The first main erasing step is therefore performed during the run-down of the printing press after completion of a printing order during a processing time, for which run-down is necessary in any event. Here, the form cylinder is still turning at high speed when it first starts to run down. As a result, during the first main erasing step, the surface of the rewritable printing form can be effectively cleaned.

During the first main erasing step, which is performed in parallel with the run-down of the printing press, i.e., with the run-down of the form cylinder upon which the printing form to be cleaned is positioned, ink and image-forming polymer are removed from the surface. For this purpose, at least one ink-dissolving cleaning agent and then at least one polymer-dissolving cleaning agent are applied by a first erasing device to the surface of the printing form. The at least one ink-dissolving cleaning agent and the at least one polymer-dissolving cleaning agent are again removed from the surface. Preferably, the cleaned surface of the rewritable printing form is dried during the first main erasing step.

Subsequent to performance of the first main erasing step and, thus, subsequent to the run-down of the form cylinder, the second main erasing step is then performed. During the second main erasing step, the surface of the rewritable printing form, which has been pre-cleaned during the first main cleaning step, is given a final cleaning, during which residual dirt is removed from the surface of the printing form. CO₂ snow can also be used for the main erasing steps.

The removal of the residual dirt from the surface of the printing form is performed during the second main erasing step by the use of a second erasing device, by means of which, for example, an atmospheric plasma is directed onto the surface of the printing form to be cleaned to remove residual dirt consisting of image-forming polymer material from the surface of the printing form. For this purpose, after the form cylinder has run-down, it is actively started up again during the second main erasing step.

The atmospheric plasma, which is an ionized gas, is directed from a defined distance onto the surface of the printing form to be cleaned. As a result, the surface of the cylinder is freed of residual dirt and is also conditioned, so that optimal adhesion of the image-forming polymer can be ensured for the following step of applying new image-forming polymer to the erased printing form. In addition, appropriate hydrophilic behavior is ensured for optimal free-running behavior when the press is started up again for a new printing order.

During the first main erasing step, which is conducted in parallel with the run-down of the form cylinder, the surface of the printing form is cleaned to a minimum degree of approximately 95%, and preferably up to a minimum degree of approximately 98%. During the second main erasing step, during which the surface of the printing form that has been pre-cleaned in the first main erasing step is given a final cleaning, the residual dirt that remains after the first main cleaning step up to a maximum amount of 5%, and preferably up to a maximum amount of 2%, is removed from the surface of the printing form.

The sole figure is a flow diagram illustrating exemplary steps of the method in an embodiment of the invention. Run-down of the form cylinder is begun, as indicated in step 100.

Next, the first main erasure of the surface of the rewritable printing form is performed, as indicated in step 110. That is, the first main erasing step is performed in parallel with the run-down of the printing press such that, with the run-down of the form cylinder upon which the printing form to be cleaned is positioned, ink and image-forming polymer are removed from the surface of the printing form.

Prior to commencement of the second main erasing step, the form cylinder is driven or restarted, as indicated in step 120.

Subsequent to performance of the first main erasing step and, thus, subsequent to the run-down of the form cylinder, the second main erasing step is then performed, as indicated in step 130. During the second main erasing step, the surface of the rewritable printing form, which has been pre-cleaned during the first main cleaning step, is given a final cleaning, during which residual dirt is removed from the surface of the printing form.

The inventive method for erasing a printing form permits significant reduction of the time required for erasure of a permanent image from a print form. The first main cleaning step of the inventive erasing method is performed in parallel with the run-down of the printing press, which in any event is required after the completion of a printing order. For the first main erasing step, the form cylinder does not have to be driven. After the printing form has been pre-cleaned during the first main erasing step, the pre-cleaned printing form is again cleaned in the second main erasing step, and the surface of the printing form is also conditioned. For the second main cleaning step, the form cylinder is actively driven again.

Thus, while there have been shown and described and pointed out fundamental novel features of the invention as applied to a preferred embodiment thereof, it will be understood that various omissions and substitutions and changes in the form and details of the method illustrated, and in their operation, may be made by those skilled in the art without departing from the spirit of the invention. It is the intention, therefore, to be limited only as indicated by the scope of the claims appended hereto.

What is claimed is:

1. A method for erasing a surface of a rewritable printing form within a printing press, a form cylinder carrying the printing form rotating during erasure of the surface of the printing form, comprising:
performing a first main erasure of the surface of the rewritable printing form during run-down of the form cylinder after completion of a printing order; and
performing a second main erasure of the surface of the rewritable printing form, during which the form cylinder is driven after completion of the run-down.

2. The method according to claim 1, wherein, during the first main erasure, the surface of the rewritable printing form is cleaned to remove ink and image-forming polymer from the surface of the rewritable printing form.

3. The method according to claim 2, wherein at least one ink-dissolving cleaning agent and then at least one polymer-dissolving cleaning agent are applied to the rewritable printing form by a first erasing device and again removed from the rewritable printing form to remove ink and image-forming polymer from the surface of the rewritable printing form.

4. The method according to claim 1, wherein, during the second main erasure, a pre-cleaned surface of the rewritable printing form is given a final cleaning to remove residual dirt from the pre-cleaned surface of the rewritable printing form.

5. The method according to claim 4, wherein an atmospheric plasma is directed onto the surface of the rewritable printing form by a second erasing device to remove residual dirt left by the image-forming polymer from the surface of the rewritable printing form.

6. The method according to claim 1, wherein, during the first main erasure, the surface of the rewriteable printing form is cleaned to a minimum degree of approximately 95%, and wherein, during the second main erasure, a maximum amount of 5% of residual dirt is removed from the surface of the rewritable printing form.

7. The method of claim 2, wherein the surface of the rewriteable printing form is dried after removal of the ink and image-forming polymer.

8. The method according to claims 2, wherein, during the second main erasure, a pre-cleaned surface of the rewritable printing form is given a final cleaning to remove residual dirt from the surface.

9. The method according to claim 3, wherein, during the second main erasure, a pre-cleaned surface of the rewritable printing form is given a final cleaning to remove residual dirt from the surface.

10. The method according to claim 2, wherein, during the second main erasure, a pre-cleaned surface of the rewritable printing form is given a final cleaning to remove residual dirt from the pre-cleaned surface of the rewritable printing form.

11. The method according to claim 3, wherein, during the second main erasure, a pre-cleaned surface of the rewritable printing form is given a final cleaning to remove residual dirt from the pre-cleaned surface of the rewritable printing form.

12. The method according to claim 2, wherein, during the first main erasure, the surface of the rewriteable printing form is cleaned to a minimum degree of approximately 95%, and wherein, during the second main erasure, a maximum amount of 5% of residual dirt is removed from the surface of the rewritable printing form.

13. The method according to claim 3, wherein, during the first main erasure, the surface of the rewriteable printing form is cleaned to a minimum degree of approximately 95%, and wherein, during the second main erasure, a maximum amount of 5% of residual dirt is removed from the surface of the rewritable printing form.

14. The method according to claim 4, wherein, during the first main erasure, the surface of the rewriteable printing form is cleaned to a minimum degree of approximately 95%, and wherein, during the second main erasure, a maximum amount of 5% of residual dirt is removed from the surface of the rewritable printing form.

15. The method according to claim 5, wherein, during the first main erasure, the surface of the rewriteable printing form is cleaned to a minimum degree of approximately 95%, and wherein, during the second main erasure, a maximum amount of 5% of residual dirt is removed from the surface of the rewritable printing form.

16. The method according to claim 6, wherein the surface of the rewriteable printing form is cleaned to a minimum degree of approximately 98%, and wherein a maximum amount of 2% of residual dirt is removed from the surface of the rewritable printing form.

17. The method according to claim 12, wherein the surface of the rewriteable printing form is cleaned to a minimum degree of approximately 98%, and wherein a maximum amount of 2% of residual dirt is removed from the surface of the rewritable printing form.

18. The method according to claim 13, wherein the surface of the rewriteable printing form is cleaned to a minimum degree of approximately 98%, and wherein a maximum amount of 2% of residual dirt is removed from the surface of the rewritable printing form.

19. The method according to claim 14, wherein the surface of the rewriteable printing form is cleaned to a minimum degree of approximately 98%, and wherein a maximum amount of 2% of residual dirt is removed from the surface of the rewritable printing form.

20. The method according to claim 15, wherein the surface of the rewriteable printing form is cleaned to a minimum degree of approximately 98%, and wherein a maximum amount of 2% of residual dirt is removed from the surface of the rewritable printing form.
